(19) United States
(12) Patent Application Publication
(10) Pub. No.: US 2014/0065436 A1
(43) Pub. Date: Mar. 6, 2014

(54) Extruded Stock

(71) Applicants: Chris Taylor, San Diego, CA (US); Steve Grangetto, San Diego, CA (US)

(72) Inventors: Chris Taylor, San Diego, CA (US); Steve Grangetto, San Diego, CA (US)

(21) Appl. No.: 14/011,737

(22) Filed: Aug. 27, 2013

Related U.S. Application Data
(60) Provisional application No. 61/694,187, filed on Aug. 28, 2012.

(51) Int. Cl. B21C 23/00; B23Q 3/06

(52) U.S. Cl. CPC B21C 23/00; B23Q 3/062
USPC 428/587; 72/260

(57) ABSTRACT

An extruded workpiece for use as raw material stock in machining is described. The material is extruded through a die that includes a section to form a clamping region, said clamping regions sized and shaped to fit the clamp of a vise used to hold parts during machining. Another embodiment describes the die used to make the workpiece and another embodiment describes a process for using the die and the work piece to generate a finished part.

### CROSS-REFERENCE TO RELATED APPLICATIONS

This application claims the benefit of U.S. Provisional Patent Application 61/694,187, filed Aug. 28, 2012, entitled “Extruded Stock” by the same inventor and hereby incorporated by reference.

### BACKGROUND OF THE INVENTION

1. Technical Field

The present invention relates to extruded tooling stock that is used as raw material for a workpiece for machining.

2. Related Background Art

A tooling fixture is used to hold a workpiece during intricate machining such as 5 axis machining. The fixture system requires that the workpiece be held securely and precisely and provides access to a machine tool to all facets of the workpiece. Preferably it is possible to prepare the raw stock and easily and removably mount the stock in the fixture to present to a machine to create a part. Previous systems for preparing the workpiece required specialty cutter tools that would precisely cut a dovetail extension onto the block of material to be tooled. This required extra steps, equipment and cost to begin a machining procedure. There is a need for an improved tooling stock that is ready made to be clamped into a fixture for machining.

### DISCLOSURE OF THE INVENTION

Workpiece material that is extruded to include a dovetail feature that will mate with a dovetail clamp used to hold the workpiece when machining is described. In other embodiments features other than a dovetail that mate with tooling fixtures may be used. In the preferred embodiment the material is extruded aluminum. In a preferred embodiment the inside corner is rounded to facilitate extruding.

### BRIEF DESCRIPTION OF THE DRAWINGS

Features are numbered equivalently through all drawings.

FIG. 1 is a diagram showing an extruded workpiece.

FIG. 2 is a detail view of the dovetail corner of the workpiece of FIG. 1.

FIG. 3 is a diagram showing the workpiece of FIG. 1 being placed in a tooling fixture.

FIG. 4 is a diagram of a die used to make the extruded workpiece.

### MODES FOR CARRYING OUT THE INVENTION

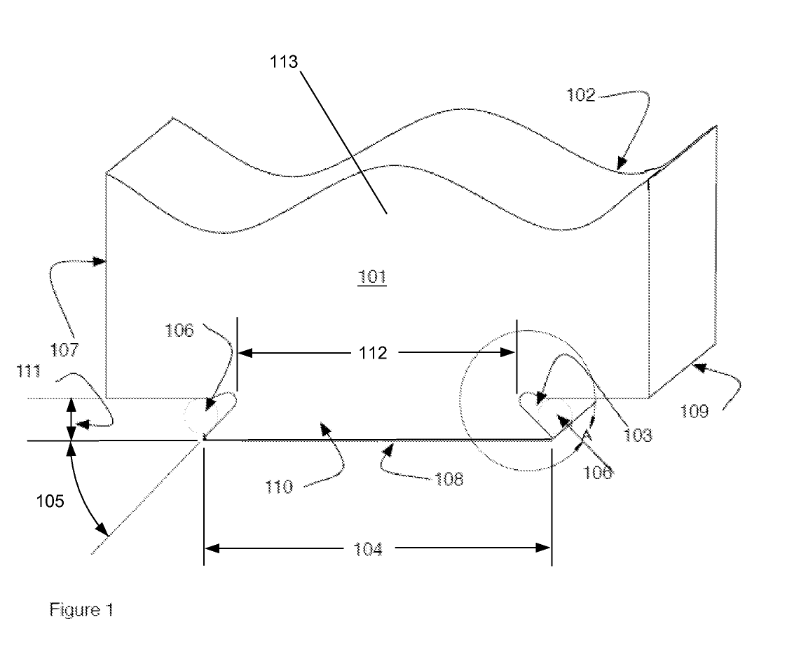

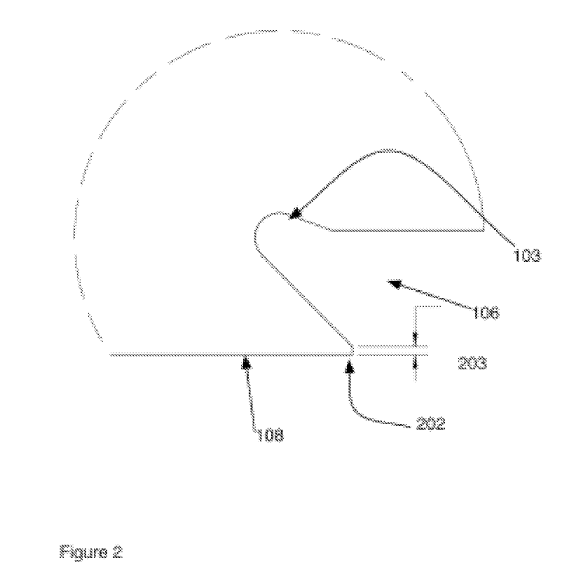

Referring to FIG. 1, an extruded work piece 101 is shown. The workpiece may be made of any material that can be extruded. Non-limiting examples include aluminum, copper, steel, titanium, brass, magnesium, plastics, ceramics and food stock. The material may be hot extruded, cold extrude or be reactive material that is extruded all as are known in the art. The particular material is dependent upon the project and is generally not limited by the products and processes shown herein. The workpiece 101 is comprised of a block of material that has been extruded to form a first section 113 having an arbitrary shape and a second section 110 having a shape that will mate with a tool fixture as is shown in a later Figure. The workpiece 101 has horizontal front base edge 108 that is the base of the workpiece and vertical edge 107, side edge 109 and top edge 102. The shape of the top edge 102, the length of the vertical edge 107 and the length of the side edge 109 (or the length of the extrusion) can vary to meet the needs of the final machined part. In one embodiment the workpiece includes a second section 110 in the shape of a dovetail. The dovetail is sized and shaped to mate with a dovetail clamp of the tooling fixture to hold the piece when machining. The dovetail is comprised of the base edge 108 having a width 104 which is larger than the width 112 where second section 110 joins first section 113. Thus, the sides of the second section 106 are slanted at an angle 105 relative to the base edge 108. In a preferred embodiment the inner corner 103 of the slanted sides 106 of the dovetail are rounded to facilitate the extrusion process. The circled section marked A is for identification of the region that is shown in a closer view in FIG. 2. The dimensions of the dovetail 104, 105, 111 are selected to match the dimensions of the dovetail vise of the fixture used to clamp the workpiece when machining. Although shown here in the preferred embodiment as a dovetail, any feature that extends from a piece intended to be clamped in a vise for machining may be used instead of the dovetail. Nonlimiting examples include a rectangular shape, a circular shape, a trapezoid, and a multipointed shape such as a star shape.

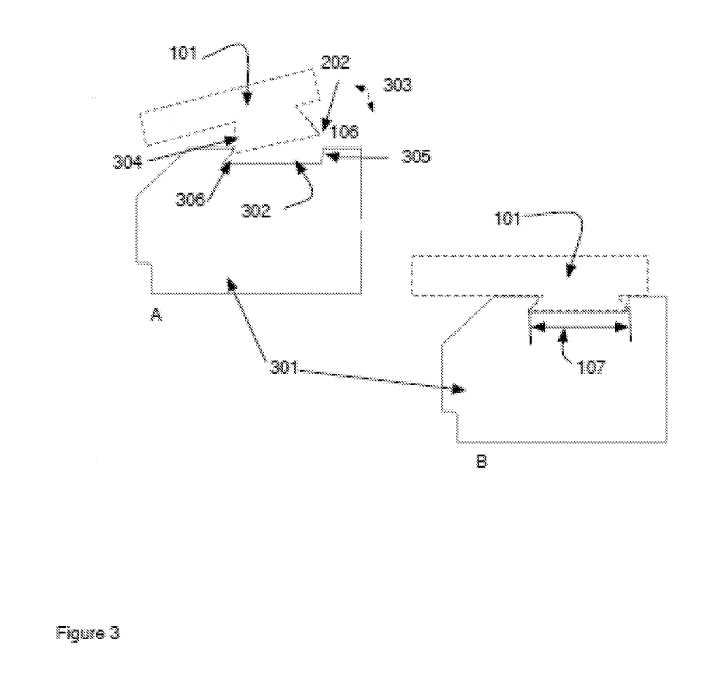

Referring to FIG. 2 a closeup of the section A of FIG. 1 is shown. The base 108 of dovetail feature and the dovetail side 106 with the rounded interior corner 103 are seen. The detail further shows that in a preferred embodiment the edge 202 of the dovetail is flattened over a width 203. The flattened edge will be seen in FIG. 3 to facilitate insertion of the workpiece into a dovetail clamp for machining.

Referring now to FIG. 3, use of the extruded workpiece by fitting into a dovetail vise 301 is seen. The vise is seen to be comprised of a female dovetail clamp 302 that is shaped and sized to mate with the extruded dovetail on the workpiece. View A shows insertion of the workpiece into the vise where a first edge 304 of the workpiece 101 is inserted into the dovetail of the vise and the piece is lowered into the vise by rotation 303. The flattened edge 202 of the dovetail on the workpiece fits against the wall 305 of the vise such that as the piece is rotated 303 into the position shown in view B the first edge 304 of the workpiece fits into the female groove 306 on the clamping vise until the workpiece 101 is in position shown in View B. The dimension 107 is selected such that the workpiece can be clamped into the vise as shown.

In other embodiments the dovetail can be replaced with other shapes such that the shape of the portion of the extruded workpiece matches a shape that can be clamped in the vise for machining.

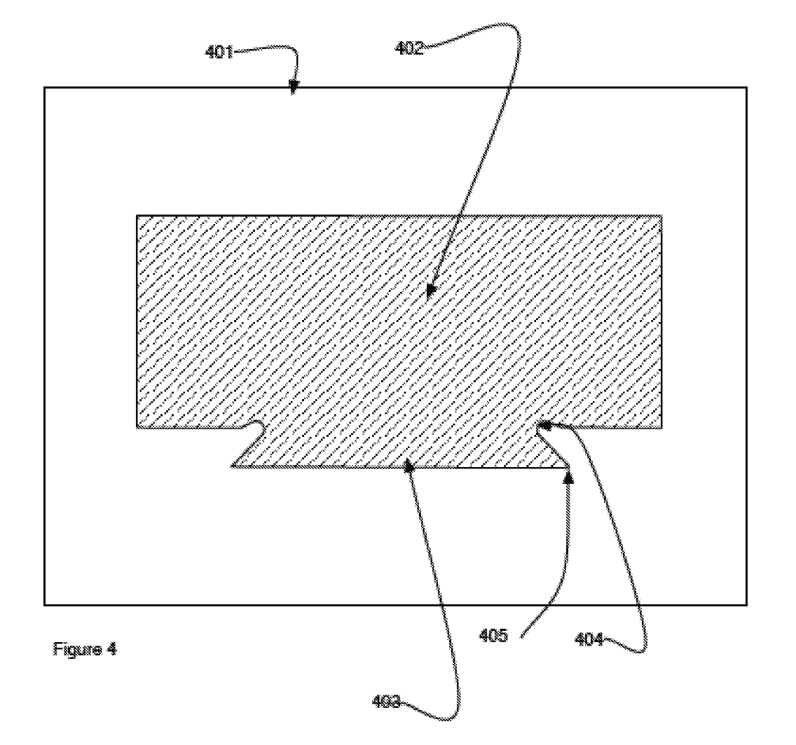

Another embodiment shown in FIG. 4 includes a die for extrusion of the workpiece. The die 401 includes a cavity 402 through which material can be extrude resulting in a workpiece that is in the shape of the cavity 402. The die includes a section 403 to be used for clamping the extruded material in a tooling fixture. In a preferred embodiment the section 403 is a dovetail as shown and in additional preferred embodiments the die includes a rounded section 404 in the interior corner of the dovetail and a flattened section 405 on at least one of the dovetail projections.

Another embodiment, not shown, includes a process for machining a part where the process includes:

1. preparing an extrusion die, said die including a section shaped and sized to be clamped in a vise to hold the part when machining,

2. extruding raw material through the die and cutting the extruded workpiece material approximately to the desired length of the part to be machined

3. clamping the extruded material in a vise, said vise including a clamping section that is shaped and sized the same as the section on the extruded clamping section on the extruded workpiece, and,

4. machining the workpiece while held in the vise.

### SUMMARY

An extruded workpiece for use as raw material stock in machining is described. The material is extruded through a die that includes a section to form a clamping region, said clamping regions sized and shaped to fit the clamp of a vise used to hold parts during machining. Another embodiment describes the die used to make the workpiece and another embodiment describes a process for using the die and the work piece to generate a finished part.

What is claimed is:

1. A raw material workpiece for machining wherein said workpiece comprises an arbitrarily shaped first section joined to a second section sized and shaped to fit a tooling vise to be held while machining the workpiece wherein the workpiece including the section sized and shaped to fit a tooling vise is made by extrusion through a die.

2. A die for making a raw material workpiece by extrusion of material through the die, said die including a section sized and shaped such that the corresponding region on the extruded workpiece will mate with a clamping section of a vise to hold the workpiece when machining.

3. The workpiece of claim 1 wherein the second section sized and shaped to fit a tooling vise is a section that protrudes from the workpiece having a length and a linearly varying width, wherein the length of the protruding section extends from a central region where it joins with the first section of the workpiece to a base end and the width of the protruding section at the central region is smaller than the width at the base end.

4. The workpiece of claim 3 wherein the corners at the junction of the first section and the second section are rounded.

5. The workpiece of claim 3 wherein the edges at the base end of the second section are flattened.

6. A process for making a raw material workpiece for machining, said process including:
a) forming a die said die shaped to include a an arbitrarily shaped first section joined to a second section, said second section being sized and shaped to match that of a clamp of a vise,
b) extruding raw material stock through the die to produce a workpiece said workpiece thereby including an arbitrarily shaped first section joined to a second section that is sized and shaped to match the clamp of the vise.

7. The process of claim 6 wherein the die is shaped such that the second section of the workpiece is a section that protrudes from the workpiece having a length and a linearly varying width, wherein the length of the protruding section extends from a central region where it joins with the first section of the workpiece to a base end and the width of the protruding section at the central region is smaller than the width at the base end.

8. The process of claim 7 wherein the die is shaped such that the corners at the junction of the first section of the workpiece and the second section of the workpiece are rounded.

9. The process of claim 7 wherein the die is shaped such that the edges at the base end of the second section of the workpiece are flattened.
